(19) United States
(12) Patent Application Publication
(10) Pub. No.: US 2026/0085212 A1
(43) Pub. Date: Mar. 26, 2026

(54) TPU printable substrate film

(71) Applicant: QUAD FILM LTD, LAS VEGAS, NV (US)

(72) Inventor: Ni Ke, LAS VEGAS, NV (US)

(73) Assignee: QUAD FILM LTD, LAS VEGAS, NV (US)

(21) Appl. No.: 19/034,493

(22) Filed: Jan. 22, 2025

(30) Foreign Application Priority Data
Sep. 25, 2024 (CN) 2024223346963

(51) Int. Cl. C09J 7/20; C09J 7/25; C09J 7/40

(52) U.S. Cl. CPC C09J 7/201; C09J 7/25; C09J 7/401; C09J 2301/302; C09J 2467/005; C09J 2475/006

(57) ABSTRACT

The present invention provides a TPU printable substrate film, comprising a first release film layer, a substrate layer, an installation adhesive layer and a second release film layer sequentially laminated; the first release film layer is provided on the substrate layer, the installation adhesive layer is provided underneath the substrate layer, and the second release film layer is provided underneath the installation adhesive layer; wherein a thickness of the first release film layer is 12^{˜}188 μm; a thickness of the substrate layer is 2^{˜}188 μm; a thickness of the installation adhesive layer is 20^{˜}100 μm and a thickness of the second release film layer is 12^{˜}188 μm. The present invention provides a TPU printable substrate film, configured for production and manufacturing of the printable decal films, and the TPU printable substrate films made by spraying coating have very good extension and anti-aging performance.

### INCORPORATION BY REFERENCE

This application claims the benefit of priority from China Patent Application No. 2024223346963 filed on Sep. 25, 2024, the contents of which are hereby incorporated by reference in their entirety.

### TECHNICAL FIELD

The present invention relates to the technical field of printable decal films, specifically a substrate film for production and fabrication of printable decal films.

### BACKGROUND TECHNOLOGY

The printable decal films for automobiles are becoming increasingly popular, the printable decal film production increases gradually, currently, the PVC printable substrate films made by casting are used, however, extension and anti-aging performance thereof is poor, the produced printable decal films are liable to be damaged during extension and service lives thereof are short. Consequently, a novel printable substrate film is in need to address the foregoing problem.

### SUMMARY OF THE INVENTION

In view of the deficiencies of the prior art, the present invention provides a TPU printable substrate film and a preparation method thereof. The TPU printable substrate film is configured for manufacturing of printable decal films, and the TPU printable substrate films made by spraying and coating has good tensile strength and anti-aging performance.

The present invention provides a TPU printable substrate film, wherein the TPU printable substrate film comprises a first release film layer, a substrate layer, an installation adhesive layer and a second release film layer which are sequentially laminated together; the first release film layer is provided on the substrate layer, the installation adhesive layer is provided underneath the substrate layer, and the second release film layer is provided underneath the installation adhesive layer.

The first release film layer having a thickness of 12^{˜}188 μm, preferably 20^{˜}125 μm, further preferably 16^{˜}75 μm; the first release film layer comprises any of thermoplastic polyurethane elastomer (TPU), thermoplastic polyurethane (TPH), polyethylene terephthalate (PET) or polypropylene (PP) (transparent, semi-transparent or colored polyester films), the first release film layer is configured to protect the substrate layer thereunder, protect the substrate layer from being contaminated during storage or transportation, and during use, the first release film layer can be released so as to print on a surface of the substrate layer thereunder.

The substrate layer having a thickness of 2^{˜}188 μm, preferably 25^{˜}100 μm, further preferably 50^{˜}75 μm, and the substrate layer is made from thermoplastic polyurethane elastomer (TPU), polyvinyl chloride (PVC), thermoplastic polyurethane (TPH), PET or polypropylene (PP); TPU is a kind of thermoplastic elastomer, which is a polymer material obtained by polymerization reaction of methylene diphenyl diisocyanate (MDI) or toluene diisocyanate (TDI) and giant-molecule polyols and polyols of low molecular weights (as chain extenders); the TPU materials have a wide range of hardness, are abrasion resistant, grease resistant and elastic, and are widely used in fields of daily commodities, sporting goods, dolls and decorative materials; and the TPU materials comprise primarily polyether-ether-ketone, polyesters and isocyanate. The PVC material is made by polymerization of vinyl chloride monomers and is a kind of common thermoplastic. The TPH material is a kind of thermoplastic, and a kind of elastomer material of high strength, high water tolerance and high abrasion resistance; can bear extreme temperature, pressure and chemical erosion, and maintain good physical performance. The PET film is also called a high temperature resistance polyester film, has excellent physical performance, chemical properties, dimension stability, transparency, and recyclability; possesses excellent mechanical properties, and a strength thereof is the highest among all the thermoplastics, tensile strength and shock strength thereof is higher than common films, extension thereof is good, size thereof is stable, and the PET film also has good thermostabilization, cold resistance, chemical agent resistance and grease resistance. The PP film comprises cast polypropylene and biaxially oriented polypropylene, and the cast polypropylene comprises isotactic polypropylene produced by extrusion blow molding and cast polypropylene (CPP) produced by T molding; the BOPP is a novel film developed to replace glass paper, and is characterized in having high mechanical strength, good ductility, transparency and lustrousness. Preferably, the substrate layers are selected from thermoplastic elastomer TPU or TPH, and more preferably, the substrate layers are made from TPU. The installation adhesive layer (also called a pressure sensitive adhesive layer) having a thickness of 20^{˜}100 μm, preferably 25^{˜}75 μm; further preferably 30^{˜}35 μm; and the pressure sensitive adhesive can be classified into a rubber type and a resin type according to the resin components. The rubber type can be divided into natural rubber and synthetic rubber; while the resin type comprises primarily acrylics, organosilicone and polyurethanes. The rubber type pressure sensitive adhesive layer comprises primarily rubber, together with auxiliary elements, such as tackifying resin, plasticizers, filling materials, viscosity adjusting agents, vulcanizing agents, antiaging agents, and solvents. And the resin type pressure sensitive adhesive layer comprises primarily resin, together with auxiliaries such as defoaming agents, flattening agents, anti-aging agents, and wetting agents.

Wherein the second release film layer having a thickness of 12^{˜}188 μm, preferably 50^{˜}170 μm, further preferably 130^{˜}150 μm; the second release film layer comprises any of TPU, TPH, PET, or PP (transparent or semi-transparent or colored polypropylene films). The release film layer is to apply a silica gel releasing agent over a surface of the PET, PE, OPP films, so to exhibit a light while stable release force relative to different organic pressure sensitive adhesives. Different organic pressure sensitive adhesives, for example, holt-melting adhesives, acrylic adhesives and pressure sensitive rubber falling into a rubber system, require different release films and release forces, in view of the viscosity of the adhesives to be released the release forces are to be adjusted, so as to have very light while stable release force. The release film layer comprises preferably a PET embossed release film, and patterns on the PET embossed release film comprise uniform grids, so that, a grid pattern can be formed on a surface of the second installation adhesive layer, and the grid pattern can be used to disseminate air inside, and the printing layer can be dry applied properly.

The preparation steps of the TPU printable substrate film are:
(1) First of all, spraying and coating a mixed solution of dissolved TPU and white inorganic coloring matters on a release film (release film for transition), wherein a weight ratio of the dissolved TPU and the white inorganic coloring matters is 94:6, coating by roller coating and drying in drying ovens, all the drying ovens are 4 m in length, totally seven drying ovens are used, with a total length of 28 m, temperature in the seven drying ovens are respectively: 60° C. in a first drying oven, 70° C. in a second drying oven, 80° C. in a third drying oven, 90° C. in a fourth drying oven, 150° C. in a fifth drying oven, 150° C. in a sixth drying oven, 90° C. in a seventh drying oven, and drying time is 3 m/min, and after drying, taking out from the drying ovens and forming the substrate layer;
(2) After drying, taking out from the drying ovens, coating the first release film layer by mirror roll attaching over a side of the substrate layer, and the first release film layer comprises PET, and making a TPU printable substrate film semi-product;
(3) Releasing the release film (release film for transition) on the substrate layer, and coating a pressure sensitive adhesive layer (installation adhesive layer) over a side of the substrate layer where the release film for transition has been removed, during which, extending with a tension of 250^{˜}300 N, no deformation is allowed, coating the pressure sensitive adhesive over the surface of the substrate layer by roller coating, and drying in the seven drying ovens, all the drying ovens are 4 m in length, with a total length of 28 m, temperature in the seven drying ovens are respectively: 70° C. in a first drying oven, 80° C. in a second drying oven, 90° C. in a third drying oven, 105° C. in a fourth drying oven, 115° C. in a fifth drying oven, 125° C. in a sixth drying oven, 90° C. in a seventh drying oven, and drying time is 13 m/min;
(4) After drying, taking out from the drying ovens, coating a second release film layer by mirror roll coating over a side of the installation adhesive layer, and the second release film layer comprises PET patterned release film, and after coating, the installation adhesive layer has patterns thereon.

Beneficial effects of the present invention: in the present invention a TPU printable substrate film is provided for production and manufacturing of printable decal films, and the TPU printable substrate film is made by spraying coating, and has good tensile strength and anti-aging performance.

### BRIEF DESCRIPTION OF DRAWINGS

FIG. 1 is a schematic diagram showing a section view of a TPU printable substrate film provided in an embodiment of the present invention.

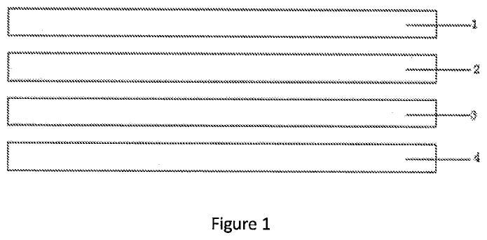

Elements in the drawings are:

First release film layer 1; substrate layer 2; installation adhesive layer 3 and second release film layer 4.

### EMBODIMENTS

Hereinafter a detailed description of the preparation steps of the TPU printable substrate film is given.
(1) First of all, spraying and coating a mixed solution of dissolved TPU and white inorganic coloring matters on a release film (release film for transition), wherein a weight ratio of the dissolved TPU and the white inorganic coloring matters is 94:6, coating by roller coating and drying in drying ovens, all the drying ovens are 4 m in length, totally seven drying ovens are used, with a total length of 28 m, temperature in the seven drying ovens are respectively: 60° C. in a first drying oven, 70° C. in a second drying oven, 80° C. in a third drying oven, 90° C. in a fourth drying oven, 150° C. in a fifth drying oven, 150° C. in a sixth drying oven, 90° C. in a seventh drying oven, and drying time is 3 m/min, and after drying, taking out from the drying ovens and forming the substrate layer 2;
(2) After drying, taking out from the drying ovens, coating the first release film layer 1 over a side of the substrate layer 2, and the first release film layer 1 comprises PET, and making a TPU printable substrate film semi-product;
(3) Releasing the release film (release film for transition) on the substrate layer 2, and coating a pressure sensitive adhesive layer (installation adhesive layer 3) over a side of the substrate layer 2 where the release film for transition has been removed, during which, extending with a tension of 250^{˜}300 N, no deformation is allowed, coating the pressure sensitive adhesive over the surface of the substrate layer by roller coating, and drying in the seven drying ovens, all the drying ovens are 4 m in length, with a total length of 28 m, temperature in the seven drying ovens are respectively: 70° C. in a first drying oven, 80° C. in a second drying oven, 90° C. in a third drying oven, 105° C. in a fourth drying oven, 115° C. in a fifth drying oven, 125° C. in a sixth drying oven, 90° C. in a seventh drying oven, and drying time is 13 m/min;
(4) After drying, taking out from the drying ovens, coating a second release film layer 4 over a side of the installation adhesive layer 3, and the second release film layer 4 comprises PET patterned release film, and after coating, the installation adhesive has patterns thereon.

### Embodiment 1

The TPU printable substrate film in the present embodiment comprises the following layers:
(1) A first release film layer having a thickness of 35 μm and being made of PET;
(2) A substrate layer having a thickness of 38 μm and being made of TPU;
(3) An installation adhesive layer having a thickness of 23 μm and being made of acrylate pressure sensitive adhesives; and
(4) A second release film layer having a thickness of 75 μm and being made of PET.

Conventionally, PVC substrate films are used as the printable substrate films, which are liable to deteriorate, and have service lives ranging from two to three years, the TPU printable substrate films made in the present invention can have service lives as long as five to ten years. Viscosity of conventional PVC substrate layers is liable to reduce, after being in use for around six months, the viscosity is liable to be reduced for 30% to 50%, however, the viscosity of the TPU printable substrate film is not liable to degrade. The conventional PVC substrate films have poor smoothness, and the surface of the TPU printable substrate film prepared in the present invention is smooth. When being used as the printable decal films, the TPU printable substrate films have good extension and anti-aging performance, viscosity and smoothness thereof is good, and the printable decal films made fit the automobiles better, and the service lives of the printable decal films are longer.

### Embodiment 2

(1) A first release film layer having a thickness of 50 μm and being made of PET;
(2) A substrate layer having a thickness of 50 μm and being made of TPU;
(3) An installation adhesive layer having a thickness of 35 μm and being made of acrylate pressure sensitive adhesives; and
(4) A second release film layer having a thickness of 140 μm and being made of PET.

### Embodiment 3

(1) A first release film layer having a thickness of 75 μm and being made of PET;
(2) A substrate layer having a thickness of 80 μm and being made of TPU;
(3) An installation adhesive layer having a thickness of 40 μm and being made of acrylate pressure sensitive adhesives; and
(4) A second release film layer having a thickness of 160 μm and being made of PET.

### Embodiment 4

(1) A first release film layer having a thickness of 90 μm and being made of PET;
(2) A substrate layer having a thickness of 95 μm and being made of TPU;
(3) An installation adhesive layer having a thickness of 50 μm and being made of acrylate pressure sensitive adhesives; and
(4) A second release film layer having a thickness of 170 μm and being made of PET.

### Embodiment 5

(1) A first release film layer having a thickness of 110 μm and being made of PET;
(2) A substrate layer having a thickness of 105 μm and being made of TPU;
(3) An installation adhesive layer having a thickness of 75 μm and being made of acrylate pressure sensitive adhesives; and
(4) A second release film layer having a thickness of 180 μm and being made of PET.

The foregoing are some exemplary embodiments of the present invention and not intended to limit the technical scope of the present invention. All equivalent replacements, variations and combinations made by those of ordinary skill in the art without departing from the spirit and principle of the present invention shall fall into the protection scope of the present invention.

1. A thermoplastic polyurethane elastomer (TPU) printable substrate film, comprising:
(1) a first release film layer having a thickness of 12^{˜}188 μm;
(2) a substrate layer having a thickness of 2^{˜}188 μm;
(3) an installation adhesive layer having a thickness of 20^{˜}100 μm; and
(4) a second release film layer having a thickness of 12^{˜}188 μm.

2. The TPU printable substrate film according to claim 1, wherein the first release film layer comprises any of thermoplastic polyurethane elastomer (TPU), thermoplastic polyurethane (TPH), polyethylene terephthalate (PET) or polypropylene (PP).

3. The TPU printable substrate film according to claim 1, wherein a thickness of the first release film layer is 16^{˜}75 μm.

4. The TPU printable substrate film according to claim 1, wherein the substrate layer is made from TPU, polyvinyl chloride (PVC), TPH, PET or PP.

5. The TPU printable substrate film according to claim 4, wherein the substrate layer is made from TPU.

6. The TPU printable substrate film according to claim 5, wherein a thickness of the substrate layer is 50^{˜}75 μm.

7. The TPU printable substrate film according to claim 1, wherein the installation adhesive layer comprises a pressure sensitive additive and has a thickness of 30^{˜}35 μm, and the installation adhesive layer serves to attach the substrate layer and the second release film layer.

8. The TPU printable substrate film according to claim 1, wherein the second release film layer is made from TPU, TPH, PET or PP.

9. The TPU printable substrate film according to claim 8, wherein the second release film layer comprises a PET patterned release film.
